(19) United States
(12) Patent Application Publication
(10) Pub. No.: US 2014/0278537 A1
(43) Pub. Date: Sep. 18, 2014

(54) NETWORK-BASED SYSTEMS AND METHODS FOR MANAGING HEALTHCARE INFORMATION

(71) Applicants: Sandeep Antony, Columbia, MD (US); Scott Afzal, Washington, DC (US); David Horrocks, Baltimore, MD (US)

(72) Inventors: Sandeep Antony, Columbia, MD (US); Scott Afzal, Washington, DC (US); David Horrocks, Baltimore, MD (US)

(21) Appl. No.: 13/844,332

(22) Filed: Mar. 15, 2013

(51) Int. Cl. G06F 19/00

(52) U.S. Cl. CPC G06F 19/322
USPC 705/3

(57) ABSTRACT

Networks are input with instructions from various types of healthcare subscribers, including identification of patients of these subscribers. Networks observe updates generated for the listed patients by healthcare providers, such as hospital encounters. The updates are numerous and update input can be rushed treatment facilities prone to error in information, so networks comprehensively filter the updates against all available instructions and identification to filter out all qualifying updates to be passed on to subscribers. Networks can format, transmit, and otherwise provide the updates based on anything commended by the client instructions. Networks may also share patient information itself with the update source to improve information association and correct client information at these sources.

### BACKGROUND

Healthcare information, including patient medical records and activities, insurance information, provider institutions, billing data, government healthcare support information, etc., across a large population can be aggregated in a health information exchange or similar database. For example, provider networks or jurisdictions may gather relevant healthcare information for all patients, providers, insurers, and other healthcare actors within the networks or jurisdictions. An example of a related art health information exchange may be Maryland's CRISP network and associated Master Patient Index. FIG. 1 is an illustration of a related health information exchange system 10. As shown in FIG. 1, system 10 includes a health information exchange 15 having a healthcare information routing and demographic matching structure 30, healthcare information database 21, and a healthcare information logic structure 20.

Healthcare information routing and demographics matching structure 30 may be a digitized or computer-based system that facilitates entry, gathering, and organization of healthcare information from one or more hospitals 50. For example, hospitals 50 may be emergency rooms, outpatient clinics, urgent care offices, pharmacies, laboratories, etc. Hospitals 50 typically provide a variety of healthcare information to health information exchange 15 via healthcare information routing and demographics matching structure 30. For example, a hospital 50 may provide clinical feeds 36 and/or patient Admit-Discharge-Transfer (ADT) messages 35 to healthcare information routing and demographics matching structure 30. Clinical feeds 36 and ADT messages 35 may include patient biographical information, treatment, other medical history, insurance information, provider activities, lab results, etc. that typically reflects healthcare information on a per patient basis. Particularly, ADT messages 35 may be generated and transmitted any time a patient has an encounter with a hospital 50, such as an admittance, discharge, transfer, to/from/within a hospital, and ADT messages 35 include this encounter information.

As shown in FIG. 1, healthcare information routing and demographics matching structure 30 may include an interface or router 32 that receives clinical feeds 36 and/or ADT messages 35 from hospitals 50. The router 32 may process or otherwise prepare data for entry into a database 21 and associated master patient index 31, which matches patient identifying information with content of database 21 to reconcile patient identity within health information exchange 15.

Subscribing participants 60 are able to access healthcare information stored in database 21 as indexed by master patient index 31 through healthcare information logic structure 20 in health information exchange 15 that is interfaced with healthcare information routing and demographics matching structure 30. Subscribing participants 60 are often emergency room physicians needing comprehensive healthcare information regarding patients who present at urgent care. Two mechanisms are typically available for providing information to subscribing participants 60. In one instance, subscribing participants 60 can login or otherwise access healthcare information logic structure 20 through a query portal 25. Subscribing participants 60 can enter queries 26 into portal 25, which is interfaced with healthcare information logic structure 20. Logic structure 20 may properly gather and/or associate data from database 21 with master patient index 31 based on the parameters of query 26 and any access/information rules applicable to system 10. In another instance, subscribing participants 60 may be delivered direct notifications 27, such as ADT messages 35, based on the content of the notifications 27.

### SUMMARY

Example methods and networks manage healthcare information in computer-based networks between several different healthcare actors. Example network accept preferences from subscribers that list patients and their information for monitoring. Networks acquire alerts for the listed patients from other exchanges, networks, or databases that receive alerts based on actions with the patients at treatment facilities, including admissions, transfers, discharges, and billing status changes. Because the alerts may be presented in massive amount and with varying quality of information, networks scrutinize the alerts against all provided patient information to ensure that only and all responsive alerts are identified. Example networks may then offer the filtered and comprehensive alerts to the properly-corresponding subscribers in any format, frequency, and manner desired. Example networks can also use the patient information itself to improve data throughput and association in the exchanges, networks, and or databases through which the alerts pass by allowing these information sources to update the alerts and their indices with the higher-quality patient information provided from subscribers.

Example methods include receiving subscriber service definitions and healthcare messages with a network, determining whether the messages correspond to the service definitions, and making corresponding subscribers aware of the matching messages. The service definitions may also be given to the source of the messages, permitting that source to better associate identifying information with message content. These actions can be formed performed regardless of numerosity of parties over a processor-based network. Information provided to subscribers may be formatted, delivered, and otherwise provided in strict accordance with subscriber service definitions.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related health information exchange system.

FIG. 2 is an illustration of an example embodiment encounter notification system.

FIG. 3 is an illustration of another example embodiment encounter notification system.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The inventors have recognized that existing encounter notification systems do not have a method for accurately and consistently alerting relevant healthcare stakeholders, such as providers and payers, when patients or members experience hospital encounters. Existing systems may use information contained within an ADT message itself to route an alert to the appropriate recipient; however, ADT data often contains errors because it is commonly recorded by hand and relies on the information a patient relays at registration, sometimes under duress at an emergency room. Further, patients often do not provide or know all relevant information or may give incorrect information. The inventors have further recognized that existing systems may pass all ADT messages directly to providers identified therein, resulting in overwhelming volume and irrelevancy of information provided. This may cause recipients to become fatigued by constant and/or low-value messaging, resulting in less useful information for care management realized by existing systems.

The present invention is a processor-dependent network that provides healthcare information to well-fitted recipients. Networks of the present invention include functionality, whether provided by hardware or software, to interface with healthcare information sources, to receive and use patient-identifying information, and to deliver healthcare information from the sources to corresponding recipients when the information is particularly timely and useful to each recipient. The present invention is also methods of providing healthcare information to well-fitted recipients using processor-dependent networks. The present invention is configurable to be used with a wide variety of healthcare information databases, services, exchanges, and providers. Example embodiments discussed below illustrate just a couple of the variety of different configurations and networks that can be used in connection with the present invention.

FIG. 2 is a diagram of an example embodiment encounter notification system 100 that can be configured through proper hardware infrastructure and software programming to execute example methods. As shown in FIG. 2, an encounter notification cluster 110 may be connected to a health information exchange 15. Encounter notification cluster 110 and health information exchange may be co-located or remote, and may be connected via a dedicated connection or bus in a same setting or over great distances through networks such as VPNs, WANs, LANs, or the Internet.

Although example embodiment encounter notification system 100 includes a related art health information exchange 15, it is understood that other types of sources for healthcare information are useable with example embodiments and methods. For example, a health system or other database may be used in place of health information exchange 15. Still further, health information exchange 15 could be fully contained within encounter notification cluster 110 to provide a centralized system for receiving, storing, processing, and/or delivering desired healthcare information to various subscribing providers 160.

As shown in FIG. 2, encounter notification cluster 110 is configured to receive subscriber parameters 120 from subscribing providers 160. Example embodiment encounter notification system 100 is useable with a wide variety of subscribing providers 160, including primary care physicians, specialists, insurance providers, hospitals, labs, etc. who may need or be able to better use specific types of healthcare information, in specific formats, in specific circumstances.

Subscriber parameters 120 define the services to be provided by example embodiment system 100. For example, subscriber parameters 120 may include a roster of patient information (hospital identifier, member ID, any names, home address, city, state, zip code, date of birth, gender, ssn, phone numbers, membership status, etc. or portions thereof) identifying patients under the care or covered by subscribing providers 160.

Subscriber parameters 120 may include a limiting set of events or circumstances for which subscribing providers 160 desire healthcare information. For example, a subscribing provider 160 who is a specialist may want only healthcare information relating to patients under the care of the specialist who have an encounter for a condition within the specialist's field of practice; or a subscribing provider 160 who is a large general practice of physicians may want cumulative healthcare information provided only once a month for a particular subset of very active patients; or an insurance provider as a subscribing provider 160 may want to be notified only when a certain type of encounter that reflects a need for patient contact or intervention occurs, such as multiple ER visits for a condition that may be successfully treated in an outpatient setting. All these limiting filters may be present in subscriber parameters 120. As such, subscriber parameters 120 may set out a roster of responsive client identification and/or a variety of circumstances for which subscribing providers 160 desire healthcare information, including any combination of event or message types based on which to create notifications, frequency of notifications, delivery format and type preferences, etc.

Each subscribing provider 160 may provide subscriber parameters 120 to encounter notification cluster 110. Subscribing providers 160 may provide multiple subscriber parameters 120 or modify existing subscriber parameters 120 as well, as their patients and needs and desires for healthcare information delivery change. Alternatively, subscriber parameters 120 may be automatically generated based on rules of example embodiment system 100 for policy compliance or service reasons. For example, a default set of subscriber parameters 120 may be provided for subscribing providers 160 who provide incomplete or incorrect parameters. Or, for example, if a subscribing provider 160 is a hospital, subscriber parameters 120 may be automatically generated for the hospital to include all patients discharged within the past 60 days, either as a desired service or to comply with regulation.

Subscriber parameters 120 may be input and/or updated into encounter notification cluster 110 through a subscriber login interface, manually from subscriber parameters 120 that are delivered, such as from a spreadsheet via email, and/or automatically generated therein based on a ruleset. Encounter notification cluster 110 may include an input structure 112 to specifically receive, process, and update/store information from subscriber parameters 120 as they are input. Input structure 112 may be, for example, a module or subroutine within encounter notification cluster 110 or may be a dedicated server with independent processing capability, depending on the configuration of encounter notification cluster 110.

Based on information provided in subscriber parameters 120, encounter notification cluster 110 can collect, compile, and provide very specific and well-tailored healthcare information to subscribing providers. As shown in FIG. 2, encounter notification cluster 110 includes a logic core 113 interfaced with and/or controlling operation of input structure 112, healthcare information source interface 111, and notification engine 114 in encounter notification cluster 110. Logic core 113 may coordinate operations, including healthcare message processing and/or delivering and enhancement of Master Patient Index (MPI) 31 through interface connection 131.

Healthcare information source interface 111 may be specifically programmed based on the configuration of known MPI 31 with which it will interface via interface connection 131, or any other health care information source instead of exchange 15. Healthcare information source interface 111 may recognize and understand how to read specific data structures or information association regimes present within MPI 31, such as client IDs, patient-identifying information, relationships among entries and records, etc., stored in MPI 31. As seen in FIG. 2, example embodiment system 100 may require only directed front-end interfaces with an external or third-party health information exchange 15, reducing complexity and/or potential for connection error problems that might exist were all other portions of exchange 15 having their own connection to encounter notification cluster 110 or if a subscriber had to directly deal with and query exchange 15. Logic core 113 and/or interface 111 may be a central routine, specifically-configured processor, and or wholly individual server with storage and processor within encounter notification cluster 110, for example, depending on the configuration of encounter notification cluster 110.

For enhancement of MPI 31, logic core 113 may provide MPI 31 with client-identifying entries from subscriber parameters 120. The client-identifying entries may be stored in MPI 31 to associate correct patient information with incoming data. For example, an existing MPI 31 may include data of a patient's name and address indexed to some patient data in a database, with data of the patient's social security number, date of birth, and gender indexed to other patient data. Logic Core 113 may provide all correct and comprehensive patient information to MPI 31 via interface 111 and interface connection 131 so that full patient-identifying information may be correctly matched with existing indices stored in MPI 31 and correctly associated with patient data. Further, when exchange 15 provides ADT messages 35 to encounter notification system 110 or otherwise, such ADT messages 35 may be properly enhanced and associated with all submitted client information going forward.

For healthcare message processing, all incoming notifications to health information exchange 15 may be monitored and/or received by encounter notification cluster 110 through interface connection 131, where interface 111 is connected to exchange 15. Incoming messages may include standard or enhanced ADT messages 35. Logic core 113 may compare the contents of ADT messages 35 against client-identifying information from a roster processed by input structure 112 from client parameters 120 to identify every message relating to a responsive client, e.g., one specifically-identified in a roster from a subscriber. In this way, logic core 113 may observe and act on every message about a patient that is responsive to a provider's roster, regardless of partial or some incorrect information being present in ADT message 35 or initially stored in MPI 31, and may properly match messages 35 with correct subscribing providers 160.

Logic core 113 may further process all messages 35 provided from exchange 15 to discard those messages or portions of messages containing duplicate, incorrect, or low-value contents. For example, a provider may generate an ADT message 35 for an internal transfer that has no meaning outside the provider facilities, or a message 35 may include typographical information of a patient's information or an impossible/redundant administrative status change, such as duplicative admittances for the same patient and facility. Logic core 113 may analyze messages for such errors, by comparing them against known correct client information, a saved history of received messages, and/or internal rulesets for impossible/plainly incorrect encounters, and identify incorrect or useless messages or portions of the same for disposal without passing them on to subscribing providers 160.

Logic core 113 may also process incoming messages 35 against subscriber parameters 120 in order to determine if messages 35 are responsive to subscriber needs and/or properly format and time any notifications generated based on the same. For example, subscribing providers 160 may provide notification limitations within parameters 120 to input structure 112 from subscriber parameters 120, such as an exclusion for particular types of encounters and/or patients. Logic core 113 may further compare such notification limitations against each ADT message 35 to exclude non-responsive messages and forwarded those complying with subscriber's notification limitations to notification engine 114 to make the ADT message available to the subscriber in accordance with any other client parameters such as delivery format or frequency.

Logic core 113 may further control notification engine 114 to generate healthcare notifications only at appropriate instances based upon subscriber parameters 120. For example, whenever logic core 113 monitors an ADT message 35 generated based on a client encounter for a client included in a roster in subscriber parameters 120, a healthcare notification may be generated for the subscribing provider 160. Alternatively, if subscriber parameters 120 requested notifications only at weekly intervals, a notification of the encounter observed in the ADT message 35 may be held until the requested interval has passed. Notification engine 114 may be a module or subroutine within encounter notification cluster 110 or may be a dedicated server with independent processing capability, for example, depending on the configuration of encounter notification cluster 110.

Healthcare notifications generated by notification engine 114 may include a wide variety of detail based on subscriber parameters and available healthcare information. For example, healthcare notifications may include only the ADT message content that triggered the notification, or healthcare notifications may include any or all healthcare information identified in MPI 31 for a patient whenever a responsive notification is generated for that patient. Subscriber parameters 120 may indicate a level and type of information requested in healthcare notifications; for example, a subscribing provider 160 may list internal identifiers, name of a primary care provider, record number, and/or any other contextual information to aid their bookkeeping that can be added into notifications by engine 114. Still alternatively, logic core 113 may select particularly high-value or relevant healthcare data for inclusion in a notification. For example, an insurance provider can submit subscriber parameters 120 requesting notifications for treatment or prescription changes, and example embodiment system 100 may provide a notification to the provider each time an ADT message 35 contains an encounter with a changed treatment or prescription; the notification may also contain information about a new condition or hospital encounter that resulted in change if this information is determined as relevant or important, for, say, determining whether the new prescription is effective or wasteful, by the logic core 113.

Notification engine 114 can prepare healthcare notifications including data present solely in encounter notification cluster 110, such as data stored in a local database that was filtered from ADT messages 35 and MPI 31 by logic core 113 and Healthcare information source interface 111, or with information accessible anywhere in example embodiment system 100. For example, Healthcare information source interface 111 may have previously identified several different data entries relating to a particular patient in MPI 31. Notification engine 114 may pull and combine all requested information among the previously-identified information in MPI 31 for presentation in a subscriber notification.

Healthcare notifications may be delivered to subscribing providers 160 through a report 127 sent via email, over a direct or secure network, through the Direct standard, in HL7 format, via Internet services, or even hard copy, based on profile information. Healthcare notifications may be structured as narratives, tables, spreadsheets, existing encounter formats, etc. For example, a subscribing provider 160 may have requested a daily notification for a list of active patients, and notification engine 114 may compile and email out a report of all encounters in HL7 format for the identified patients within a daily interval. Alternatively, healthcare notifications may be prepared and stored with notification engine 114 and provided to subscribing providers 160 only upon their access 128 to encounter notification cluster 110; a reminder of a new healthcare notification may still be provided in this instance. Still further, a subscribing provider 160 may receive notifications via the Direct standard in real-time, permitting providers to readily follow-up with patients at each encounter, such as admission or discharge.

Given the variety of example functions described above, encounter notification cluster 110 may be structured in a variety of ways to provide desired functionality. Although logic core 113 is shown as a separate structure or routine connected to other parts within encounter notification cluster 110, it is understood that logic core 113, and its operations and controls, may be incorporated in relevant part in any of input structure 112, healthcare information source interface 111, and/or notification engine 114. Other divisions of structures and functionalities 111, 112, 113, and 114 among any number of separate modules, processors, servers are useable with example embodiment system 100, including execution on a single machine or among distance exclusive servers and processors.

Further, connections shown in example embodiment 100 can be over the Internet, including standard communications protocols such as TCP/IP, or through a programmed application configured to interact with and exchange data in dedicated network or intranet. Servers within example embodiment system 100 may include, for example, conventional domain and/or security protocols for access and authentication as well as processing capacities to retrieve, deliver, and/or format data for use within example embodiment system 100. Or, for example, all of example embodiment system 100 may be configured in a single machine, with an internal bus providing communication between various elements. Further, encounter notification cluster 110 may also include its own data storage capabilities to handle and persist user inquiries and/or create a processed database mirroring in part data from separate MPI 31.

FIG. 3 is an illustration of another example embodiment encounter notification system 200 useable with example methods. Example embodiment system 200 may include several similar aspects to example embodiment system 100 described in FIG. 2, redundant details of which are omitted. As shown in FIG. 3, example embodiment encounter notification cluster 110 may be connected to several health information sources, such as health information exchanges or databases 15a and 15b compiled by separate states or hospital or insurance networks.

As shown in FIG. 3, second exchange 15b may include an intake processor or router 32b to which notification engine 114 may provide ADT messages 135 that were originally received and processed (and enhanced with patient information) from exchange 15a. In this way, example embodiment systems may further share information and well-associated ADT messages through several different exchanges between which patients may move. As also seen in FIG. 3, any number of additional encounter notification system clusters X10 can operate like cluster 110 for these additional exchanges, eventually providing new data from other exchanges 15b or otherwise back into router 32a.

Example methods and embodiments thus being described, it will be appreciated by one skilled in the art that example embodiments may be varied through routine experimentation and without further inventive activity. For example, subscribers are described as providing subscriber parameters to define the parameters of their information delivery service, it is understood that subscriber parameters may be automatically received in example embodiment networks for any subscriber through default options, a controlling ruleset, or through other controlling subscribers. Variations are not to be regarded as departure from the spirit and scope of the exemplary embodiments, and all such modifications as would be obvious to one skilled in the art are intended to be included within the scope of the following claims.

What is claimed is:

1. A method of managing healthcare information with a processor-based healthcare notification delivery network, the method comprising:
receiving, at the healthcare notification delivery network, subscriber parameters including patient-identifying information for a subscriber;
receiving, with the healthcare notification delivery network, a healthcare information message from a healthcare information source;
comparing, with the healthcare notification delivery network, the healthcare information message with the patient-identifying information; and
providing a healthcare notification to the subscriber, wherein the healthcare notification includes at least a portion of the healthcare information message, and wherein the providing is executed only if the comparing determines that the healthcare information message corresponds to the patient-identifying information.

2. The method of claim 1, wherein the subscriber parameters further include format and frequency information for the healthcare notification, and wherein the providing includes providing the healthcare notification in the format and at the frequency to the subscriber.

3. The method of claim 1, wherein the receiving the subscriber parameters includes automatically generating the subscriber parameters for the subscriber only in accordance with preexisting rules for when the subscriber does not provide the subscriber parameters.

4. The method of claim 1, wherein the subscriber is one of a healthcare provider, an insurance provider, and a government agency, and wherein the patient-identifying information includes at least a portion of the patient's, name, address, city, state, zip code, social security number, date of birth, phone number, and gender.

5. The method of claim 1, wherein the healthcare information message is an ADT message generated by a healthcare provider in response to a patient encounter, and wherein the healthcare notification includes information contained in the ADT message.

6. The method of claim 5, wherein the healthcare information source is a health information exchange operated and controlled by a separate operator and controller from the healthcare notification delivery network.

7. The method of claim 6, further comprising:
transmitting, from the healthcare notification delivery network to the healthcare information source, the patient-identifying information, and wherein the healthcare information message has been enhanced with the transmitted patient-identifying information by the healthcare information source.

8. The method of claim 1, wherein the subscriber parameters further include a filter, and wherein the providing is further executed only if the healthcare notification contains information not excluded by the filter.

9. The method of claim 1, further comprising:
determining, with the healthcare notification delivery network, whether the healthcare information message contains is incorrect and whether the healthcare information message is of low value to the subscriber, wherein the providing is further executed only if the determining determines that the added healthcare information is correct and not of low value to the subscriber.

10. The method of claim 1, wherein the healthcare notification delivery network includes,
an interface configured to connect to the healthcare information source and perform the receiving the healthcare information message,
an intake structure configured to perform the receiving the subscriber parameters, and
a notification structure configured to perform the providing.

11. The method of claim 1, wherein the providing the healthcare notification includes at least one of transmitting the notification to the subscriber and alerting the subscriber that the healthcare notification is available for access from the healthcare notification delivery network.

12. The method of claim 1, further comprising:
providing the healthcare notification to a different health information source.

13. A method of managing healthcare information with a processor-based healthcare notification delivery network, the method comprising:
receiving, at the healthcare notification delivery network, subscriber parameters including patient-identifying information for a subscriber;
transmitting, from the healthcare notification delivery network to a healthcare information source, the patient-identifying information; and
receiving, with the healthcare notification delivery network, a healthcare information message from the healthcare information source, wherein the healthcare information message has been enhanced with the transmitted patient-identifying information by the healthcare information source.

14. The method of claim 13, wherein,
the subscriber is one of a healthcare provider, an insurance provider, and a government agency,
the patient-identifying information includes at least a portion of the patient's, name, address, city, state, zip code, social security number, date of birth, phone number, and gender,
the healthcare information source is a health information exchange controlled and operated by a party different than the healthcare notification delivery network, and
the healthcare information message is an ADT message generated by a healthcare provider in response to a patient encounter.

15. The method of claim 13, further comprising:
comparing, with the healthcare notification delivery network, the healthcare information message with the patient-identifying information; and
providing a healthcare notification to the subscriber, wherein the healthcare notification includes at least a portion of the healthcare information message, and wherein the providing is executed only if the comparing determines that the healthcare information message corresponds to the patient-identifying information.

16. A processor-based healthcare notification delivery network for managing healthcare information, the network comprising:
an interface configured to receive healthcare information messages from a healthcare information source;
an intake module configured to receive subscriber parameters including patient-identifying information for a subscriber; and
a delivery module configured provide a healthcare notification to the subscriber only if the healthcare information message corresponds to the patient-identifying information, wherein the healthcare notification includes at least a portion of the healthcare information message.

17. The network of claim 16, further comprising:
a logic module configured to control and pass data between the interface, the intake module, and the delivery module.

18. The network of claim 16, wherein the interface is further configured to transmit patient-identifying information to the healthcare information source.

19. The network of claim 16, wherein the interface is further configured to communicate with a plurality of differently-controlled healthcare information sources.

20. The network of claim 16, wherein,
the subscriber is one of a healthcare provider, an insurance provider, and a government agency,
the patient-identifying information includes at least a portion of the patient's, name, address, city, state, zip code, social security number, date of birth, phone number, and gender,
the healthcare information source is a health information exchange controlled and operated by a party different than the healthcare notification delivery network, and
the healthcare information message is an ADT message generated by a healthcare provider in response to a patient encounter.
